(19) United States
(12) Patent Application Publication
(10) Pub. No.: US 2018/0218437 A1
(43) Pub. Date: Aug. 2, 2018

(54) FOOT AND FOOTWEAR ANALYSIS CONFIGURATION

(71) Applicant: Willow Garage, Inc., Menlo Park, CA (US)

(72) Inventors: Radu B. Rusu, San Francisco, CA (US); Suat Gedikli, Munchen (DE)

(21) Appl. No.: 15/936,561

(22) Filed: Mar. 27, 2018

Related U.S. Application Data
(63) Continuation of application No. 14/700,575, filed on Apr. 30, 2015, now abandoned.
Application No. 14/700,575 is a continuation of application No. 13/921,182, filed on Jun. 18, 2013, now abandoned.
(60) Provisional application No. 61/661,308, filed on Jun. 18, 2012.

(51) Int. Cl. G06Q 30/06; G06T 7/40; G06F 17/30; G06K 9/00; G06K 9/52

(52) U.S. Cl. CPC G06Q 30/0631; G06T 7/40; G06F 17/3028; G06K 9/52; H04N 13/0203; G06K 9/00362

(57) ABSTRACT

One embodiment is directed to system for analyzing the feet of a subject, wherein the subject may position and orient his feet in a capture configuration relative to a 3-dimensional camera, and the 3-dimensional camera may be utilized to capture a plurality of images about the subject's feet from a plurality of perspectives. A point cloud may be created based upon the captured images, and extraction procedures may be conducted to create individual, or discrete, point clouds for each of the feet from the overall superset point cloud created using the 3-dimensional imaging device. The discrete point clouds may be utilized to conduct various measurements of the feet, which may be utilized in various configurations, such as for shoe fitment or manufacturing.

### RELATED APPLICATION DATA

The present application is a continuation of U.S. patent application Ser. No. 14/700,575, filed on Apr. 30, 2015, which is a continuation of U.S. patent application Ser. No. 13/921,182 filed Jun. 18, 2013, which claims the benefit under 35 U.S.C. § 119 to U.S. Provisional Applications Ser. No. 61/661,308 filed Jun. 18, 2012. The foregoing applications are hereby incorporated by reference into the present application in their entirety.

### FIELD OF THE INVENTION

The present invention relates generally to systems and methods for analyzing the geometry of one or more feet of a subject and applying the geometric information to facilitate footwear and accessory design, manufacturing, and/or functionality.

### BACKGROUND

With modern design and manufacturing technologies, footwear design and fitment has become an art of applied mechanics of materials, materials science, mechanical engineering, and other specialties. To facilitate the demand and desire for persons to design, manufacture, analyze, or wear specifically-fitted or designed footwear, there is a need for convenient technologies to determine the geometry of the feet of a particular subject.

### BRIEF DESCRIPTION OF THE DRAWINGS

FIG. 1 depicts a runner's foot in a running shoe.

FIG. 2 depicts the feet of a subject person.

FIG. 3A depicts one configuration of a 3-D imaging device capturing an image of the feet of a subject person from a first perspective.

FIG. 3B depicts one configuration of a 3-D imaging device capturing an image of the feet of a subject person from a second perspective.

FIG. 3C depicts a superset point cloud created using a 3-dimensional imaging device.

FIG. 3D depicts a close-up view of a portion of a superset point cloud created using a 3-dimensional imaging device.

FIG. 3E depicts an alternate close-up view of a portion of a superset point cloud created using a 3-dimensional imaging device.

FIG. 3F depicts another alternate close-up view of a portion of a superset point cloud created using a 3-dimensional imaging device.

FIG. 3G depicts one view of two discrete foot point clouds representative of the feet of a subject that have been extracted from the greater superset point cloud.

FIG. 3H depicts another view of two discrete foot point clouds representative of the feet of a subject that have been extracted from the greater superset point cloud.

FIG. 3I depicts a partial view of two discrete foot point clouds representative of the feet of a subject that have been extracted from the greater superset point cloud, with a measurement plane cutting through each of the discrete point clouds.

FIG. 4 illustrates one embodiment of a procedure for utilizing an embodiment of a foot and footwear analysis configuration featuring a 3-D imaging device.

FIG. 5A depicts one configuration of a stereo imaging device capturing an image of the feet of a subject person from a first perspective.

FIG. 5B depicts one configuration of a stereo imaging device capturing an image of the feet of a subject person from a second perspective.

FIG. 6 illustrates one embodiment of a procedure for utilizing an embodiment of a foot and footwear analysis configuration featuring a stereo imaging device.

FIG. 7A depicts one configuration of a mono imaging device capturing an image of the feet of a subject person from a first perspective.

FIG. 7B depicts one configuration of a mono imaging device capturing an image of the feet of a subject person from a second perspective.

FIG. 8 illustrates one embodiment of a procedure for utilizing an embodiment of a foot and footwear analysis configuration featuring a single imaging device.

FIG. 9 illustrates one embodiment of a system for foot and footwear analysis in accordance with the present invention.

### SUMMARY OF THE INVENTION

One embodiment is directed to a footwear configuration system, comprising: a local image capture device operatively coupled to a local computing system; and a centralized image processing and analysis computing system operatively coupled to the local computing system, the local image capture device, and a centralized data storage device; wherein the local image capture device is configured to capture image information pertinent to a subject's foot from two or more different perspectives while the subject is standing upon a floor surface with and without a shoe, and to transmit such image information to the local computing system; and wherein the local computing system is configured to transmit the image information to the centralized computing system to facilitate the centralized computing system in creating a surface model of the subject's foot, and to automatically analyze the fit of the shoe to the foot based at least in part upon a predetermined model of the geometry of the shoe that is stored on the centralized data storage device. The centralized computing system further may be configured to send back to the local computing system information regarding the surface model of the subject's foot and the fit of the shoe to the foot for display and analysis on the local computing system. The local image capture device may be selected from the group consisting of: a mono imaging device, a stereo imaging device, and a 3-D imaging device. The local image capture device may be a mono imaging device selected from the group consisting of: an SLR camera and a cellphone camera. The local image capture device may be a 3-D imaging device, and the image information may comprise a point cloud. The local image capture device may be configured to capture the image information while the subject is standing on a textured surface. The local image capture device may be configured to capture the image information while the subject is standing on the floor surface wearing a textured sock over the foot. The local image capture device may be operatively coupled to the local computing system by a wireless data connection. The local image capture device may be operatively coupled to the local computing system by a wired data connection. The local image capture device may be operatively coupled to the local computing system by an exchanged memory device. The local computing system may be operatively coupled to the centralized computing system by an internet connection modality. The internet connection modality may be selected from the group consisting of: a wired network connection and a wireless network connection. The local computing device may comprise a personal computer.

Another embodiment is directed to a method for footwear configuration, comprising: capturing, using a local image capture device, image information pertinent to a subject's foot from two or more perspectives while the subject is standing upon a floor surface with and without a shoe; transmitting the image information to a local computing system; and utilizing the local computing system to transmit the image information to a centralized computing system to facilitate the centralized computing system in creating a surface model of the subject's foot, and to automatically analyze the fit of the shoe to the foot based at least in part upon a predetermined model of the geometry of the shoe that is stored on the centralized data storage device. The method further may comprise sending back to the local computing system information regarding the surface model of the subject's foot and the fit of the shoe to the foot for display and analysis on the local computing system. The method further may comprise utilizing the information regarding the surface model of the subject's foot and the fit of the shoe to the foot to select an appropriate shoe for the foot. The method further may comprise utilizing the information regarding the surface model of the subject's foot and the fit of the shoe to the foot to manufacture a customized shoe for the foot.

### DETAILED DESCRIPTION

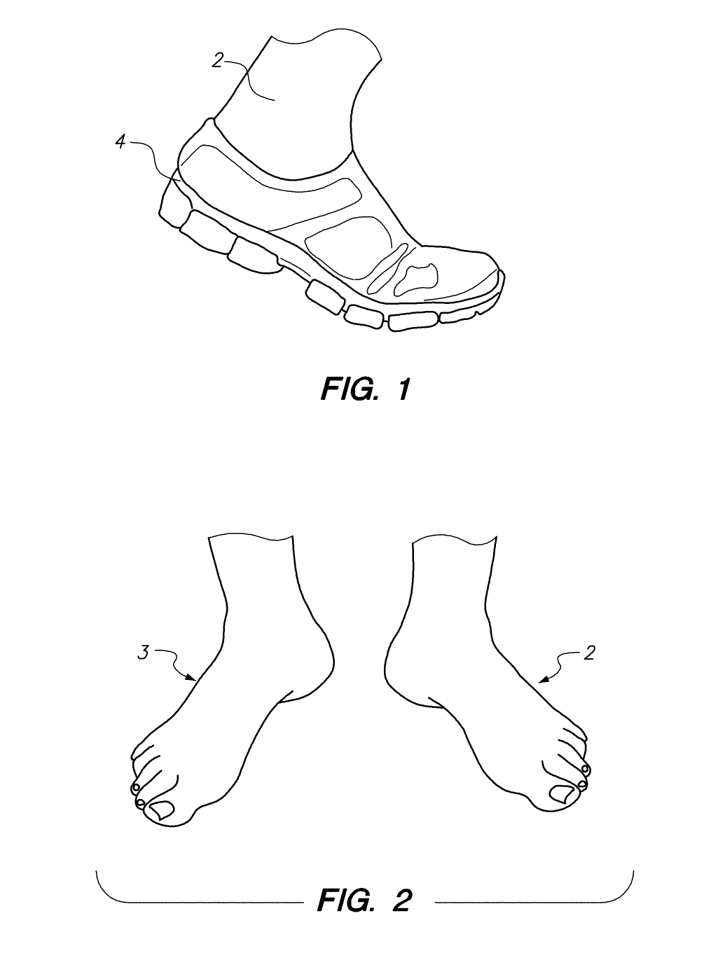

Referring to FIG. 1, a person's foot (2) is shown in a shoe (4), such as a running shoe. Referring to FIG. 2, a person's feet (2, 3) are shown standing upon a flat surface such as a floor. To accurately and conveniently geometrically characterize the feet of the person, in one embodiment, a 3-dimensional (“3-D”) imaging device, such as a 3-D camera, which may be purchased, for example, for Microsoft Corporation under the tradename Kinect®, may be utilized to capture a plurality of images from a plurality of perspectives about the feet of the subject person.

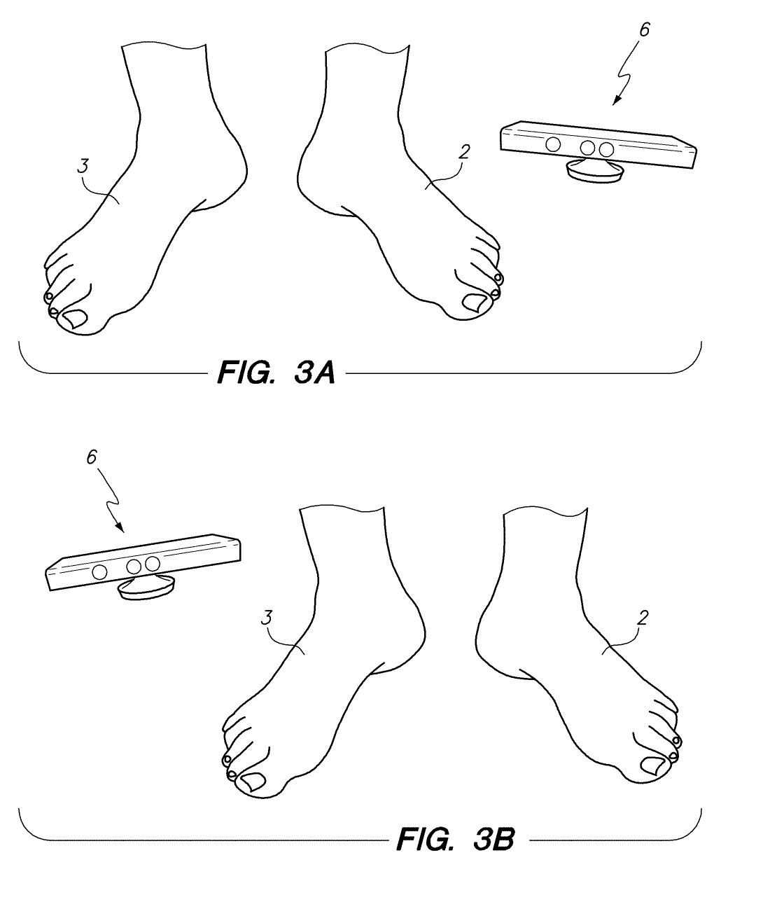

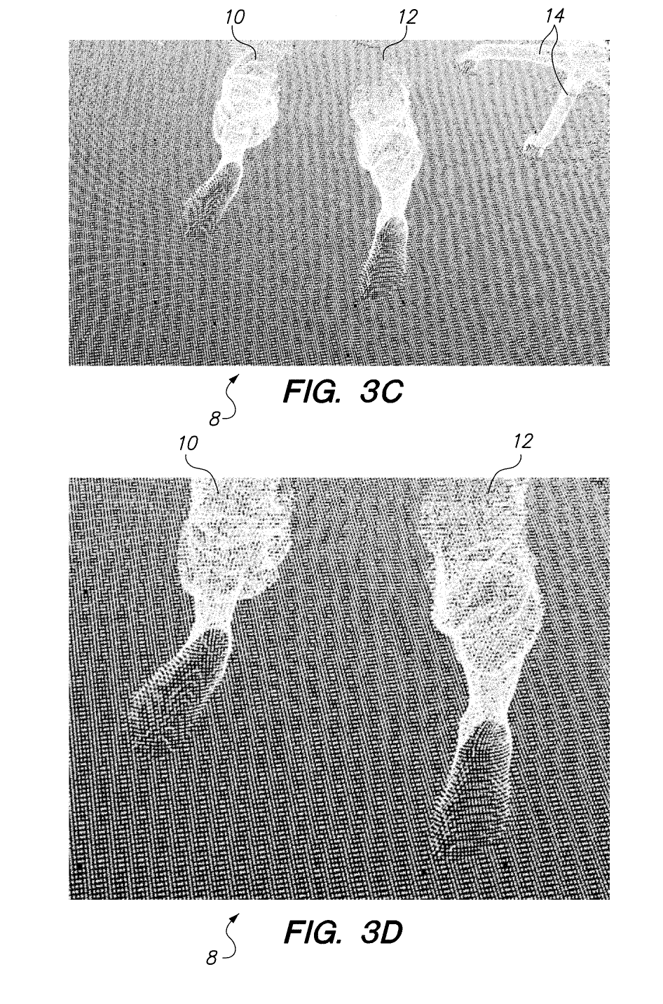

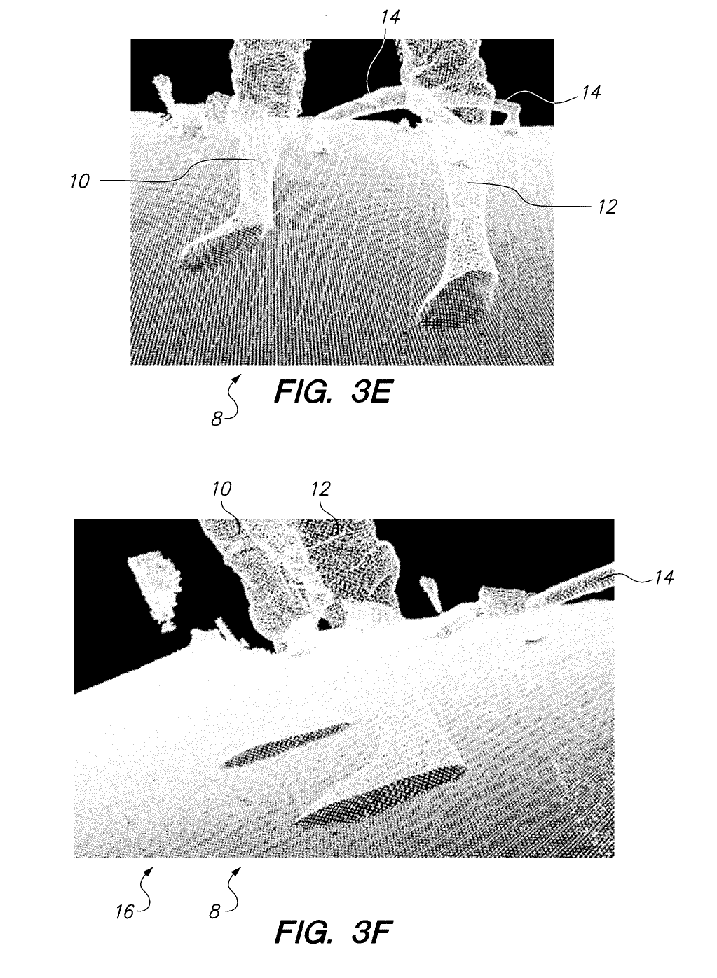

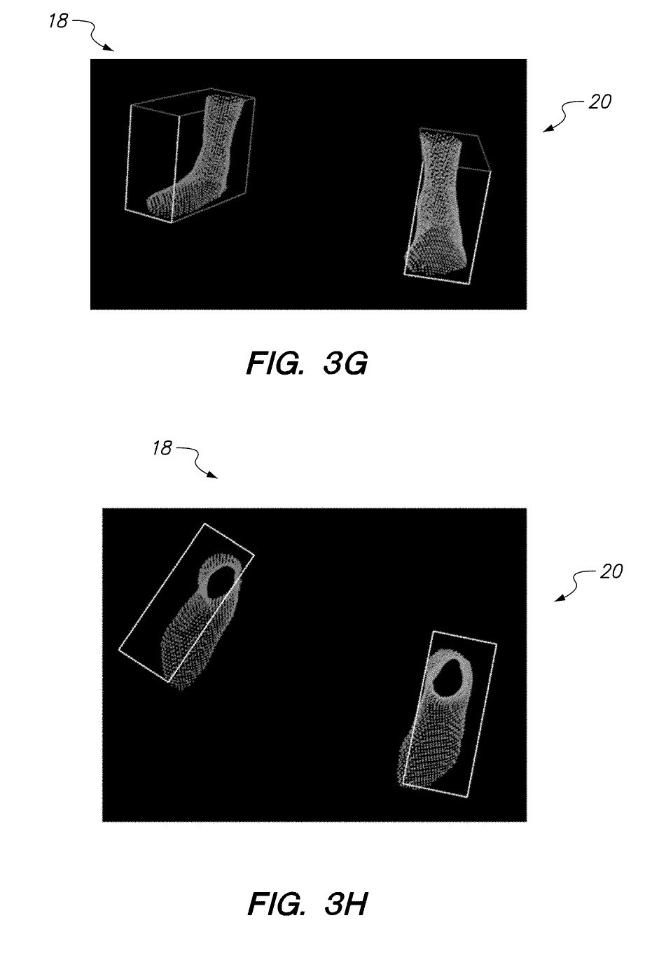

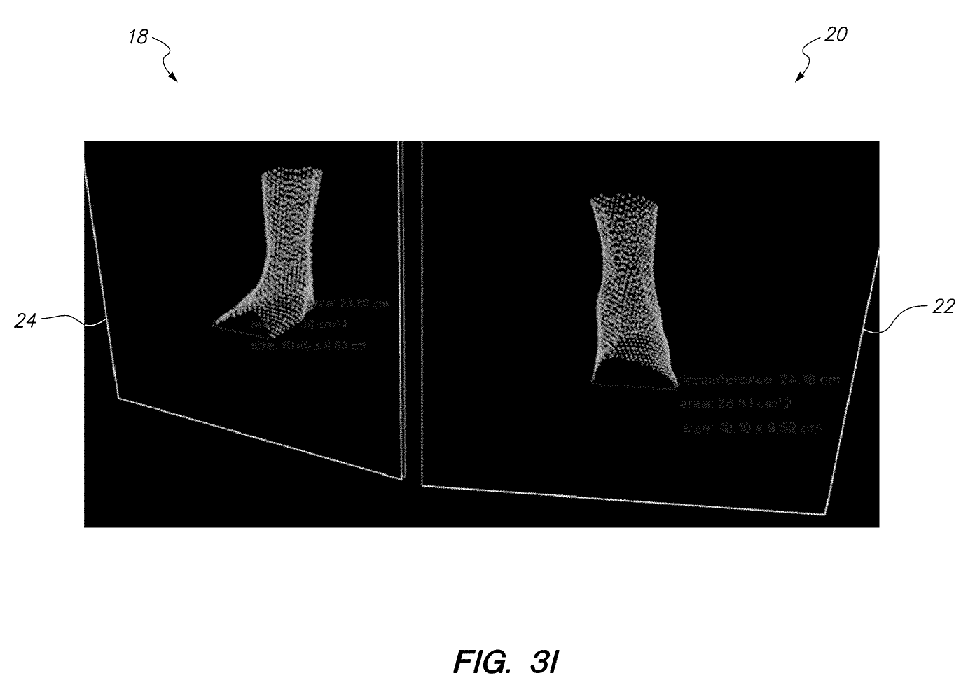

Referring to FIG. 3A, a 3-D imaging device (6) is shown having a field of capture with a first perspective relative to the feet (2, 3) of the subject person; in FIG. 3B, a different perspective relative to the feet (2, 3) is depicted. The captures may comprise discrete captures from different points in time (i.e., one capture, then a movement of the device 6, then another capture), or may comprise members of a sequential and continuous series of captures saved from a continuous capture mode as the device (6) is moved around the feet (2, 3) of the subject with the device (6) continuously capturing. The device (6) may be operated by the subject person himself, by another assistant person, or by an electromechanical structure configured to hold the device (6) and move it about relative to the feet of the subject, such as in a small shoe-store style imaging kiosk, which may be cylindrical in shape to at least partially surround the feet of the subject and facilitate movement of the imaging device (6) relative to the feet (2, 3). In another embodiment, only one foot may be imaged in a configuration wherein the focus of the analysis is one single foot, and data from the other foot would be of only marginal utility. The image acquisition may be conducted offline (i.e., with the image capture device 6 acquiring and storing data to be analyzed by a computing system later—in one embodiment via submission over the internet to a centralized computing system configured for such analysis), or online, in a configuration wherein a computing system is operatively coupled to the imaging device (6), to facilitate real-time, or near-real-time analysis of the data, such as by using a high-speed graphics processing unit (“GPU”), such as those available from nVidia Corporation to be used with personal computing systems. In one embodiment, images may be captured at a mesh of angular spacing about the feet of the subject person (i.e., if a Z axis is oriented substantially aligned with the spine of the subject person when standing up straight, one or more images may be captured at intervals no larger than a specified interval, as the imaging device is rotated about the Z axis; for example, in one embodiment, the mesh/interval may require that at least one image be acquired every 30 degrees or less; in another embodiment a mesh/interval of 60 degrees, 90 degrees, or more may suffice; in another embodiment, simply placing the capture device 6 in a continuous capture mode and waving the capture device 6 generally in a circle around the person's feet may suffice for data capture; in one embodiment, the computing system may circle back to an operator and request that more data be required from one or more approximate perspectives).

Referring to FIG. 3C, a superset point cloud (8) may be created with the data from the imaging device (6) multi-perspective capture information. The feet of a human have unique geometry, so techniques such as “iterative closest point”, or “ICP”, may be utilized to assist with putting all of the data into one coordinate system framework. In the depicted configuration, the superset point cloud (8) features point sub-clusters that appear to be related to the legs and feet of the subject (10, 12); also shown in the superset point cloud (8) are what appear to be representations (14) of some support structures of an office chair that was nearby during the imaging device (6) image capturing. FIG. 3D shows a close up view of the point sub-clusters of the point cloud (8) that appear to be related to the legs and feet of the subject (10, 12). FIGS. 3E and 3F illustrate alternative views of aspects of the superset point cloud (8) that appear to represent the feet of the user (10, 12), the office chair (14) that was nearby during image acquisition, and the floor (16) upon which the subject was standing during image capture.

Referring to FIG. 3G, portions of the data from the superset point cloud (element 8 of FIG. 3F, for example) may be extracted to isolate discrete point clouds (18, 20) that are representative of the feet of the subject person. In one embodiment, this may comprise manual selection of the feet from the superset point cloud, such as by using a pointing device like a computer mouse; in another embodiment, the operatively coupled computing system may extract the discrete foot point clouds automatically, such as by doing “foot recognition” analysis based upon known anthropomorphic parameters of the human foot, or by extracting clusters of points that reside above the plane of the dominant plane or floor upon which the feet were standing, and then applying parameters that generally are related to human feet, such as certain volumes, diameters, regularity of diameter, measurement length ranges, and the like. FIG. 3H illustrates a different view of the same extracted discrete foot point clouds (18, 20) shown in FIG. 3G.

Referring to FIG. 3I, computerized cutting planes (22, 24) or other computerized measuring tools may be utilized to measure cross sectional areas, lengths, diameters, and other aspects of the subject feet directly from the discrete point clouds. In another embodiment, the point cloud data may be mathematically segmented to, for example, create a triangular mesh mathematical surface model of each of the feet, so that further surface and geometry analysis may be conducted via computing system.

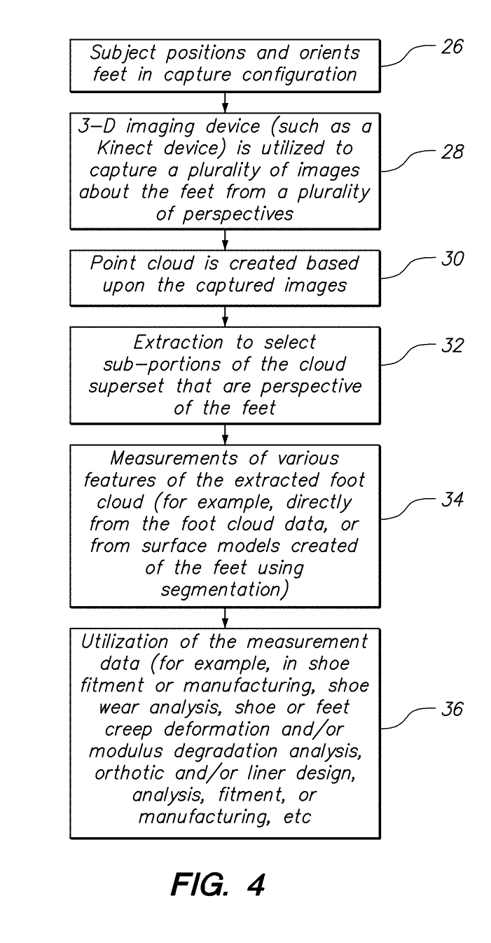

Referring to FIG. 4, a process for utilizing various steps described above in reference to FIGS. 3A-3I is depicted in flowchart form. The subject person may position/orient his feet in a capture configuration (26), which may represent a substantially stable configuration such as standing flat footed on a floor, or which may represent a more dynamic configuration, such as standing upon one's toes, or upon one foot, for example. The 3-D imaging device may be utilized to capture the plurality of images of the feet from a plurality of perspectives (28), and a superset point cloud may be created (30). Subsequently extraction techniques may be utilized to create discrete point clouds representative of the discrete feet (32). Measurements may be conducted using the discrete point cloud data itself, or model information that may be developed using the discrete point cloud data, such as segmentation model-based analysis outputs (34). The measurement data may be utilized in many inventive processes (36). For example, in one embodiment, custom shoes, orthotics, or shoe liners may be created in accordance with the geometry of the subject person's very own feet, or shoes that he intends to utilize with liners and/or orthotics. In another embodiment, finite element analysis of the subject person's foot and of the associated structures (shoe, liner, orthotics, etc) and dynamic scenario (jumping acceleration, body mass, etc) to model contact loading patterns and loading “hotspots”. In another embodiment, shoe wear analysis may be analyzed—geometrically, and/or by applied finite element analysis to characterize creep deformation and/or modulus changes in the shoe, liner, and/or orthotic materials—or even in the foot materials (calcified and noncalcified tissue).

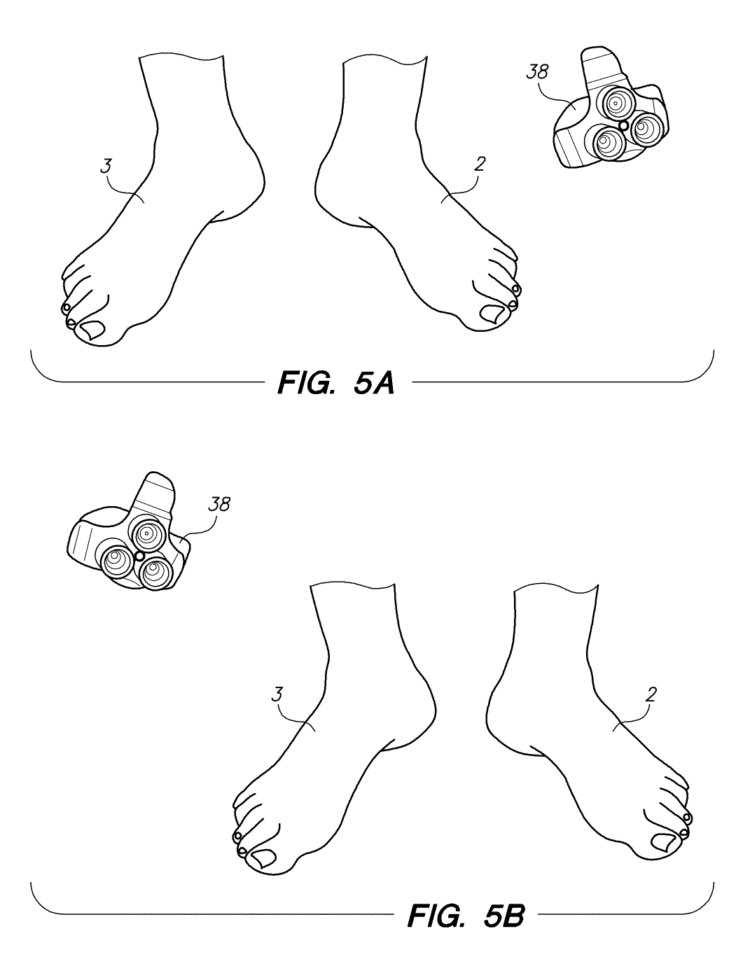

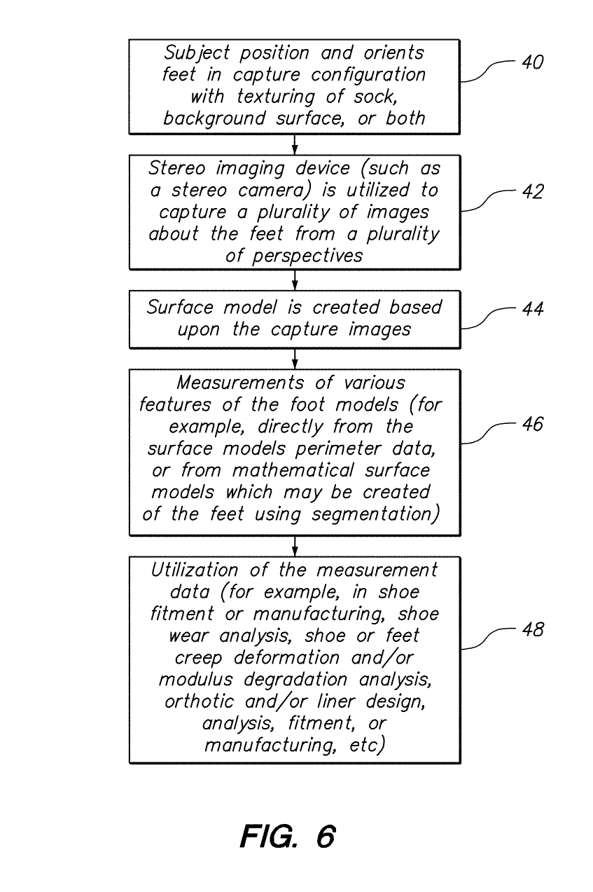

Referring to FIGS. 5A and 5B, a stereo imaging device (38), such as that available from Zeiss under the tradename Zeiss Stereoscopic Camera® by Zeiss corporation of Germany, may be utilized in place of the 3-D imaging device of the aforementioned embodiments to capture images from a plurality of perspectives. To facilitate 3-dimensional analysis of the same object from two nearby perspectives built into the stereo imaging device, textured socks may be worn by the subject person, or a textured floor image may be utilized below the feet. As shown in FIG. 6, with the subject person's feet positioned for imaging with the textured socks and/or background surface (40), the imaging device may be utilized to capture a plurality of images (42), which may be utilized to create a model (44) of the feet. The model may be utilized to measure various aspects of the feet (46), and these measurements may be utilized (48) in a similar manner to those described above in reference to FIG. 4.

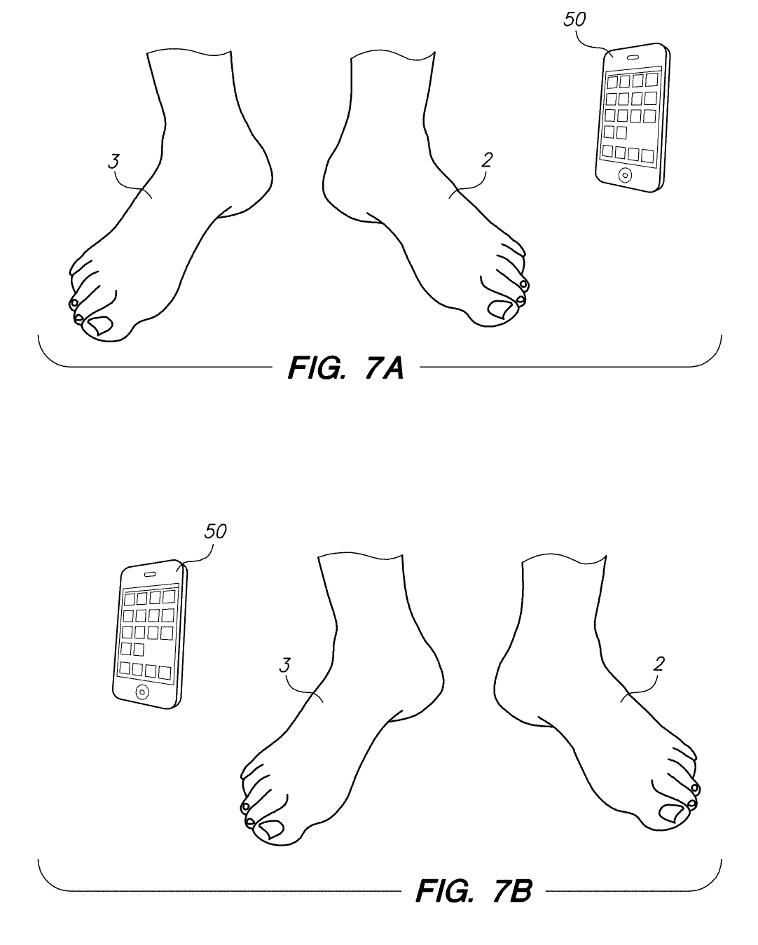

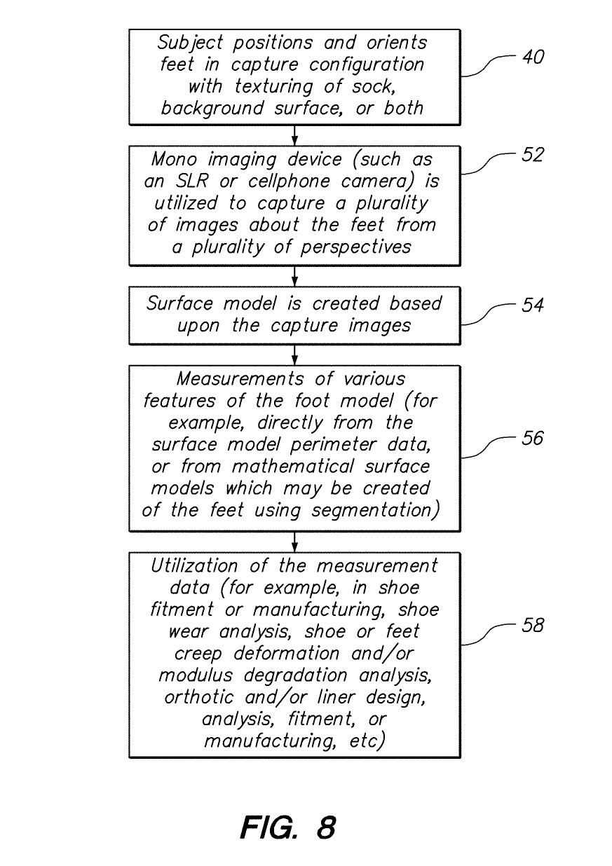

Referring to FIGS. 7A and 7B, a mono (i.e., single image capture device) imaging device (50), such as that available from Apple Computer Corporation under the tradename iPhone® (i.e. the camera or video aspect of the iPhone; similarly, almost any conventional camera, such as a webcam or digital SLR camera may be utilized), may be utilized in place of the 3-D imaging device or stereo imaging device of the aforementioned embodiments to capture images from a plurality of perspectives with a single imaging device. To facilitate 3-dimensional analysis of the same object from multiple perspectives, textured socks may be worn by the subject person, or a textured floor image may be utilized below the feet. As shown in FIG. 8, with the subject person's feet positioned for imaging with the textured socks and/or background surface (40), the imaging device may be utilized to capture a plurality of images (52), which may be utilized to create a model (54) of the feet. The model may be utilized to measure various aspects of the feet (56), and these measurements may be utilized (58) in a similar manner to those described above in reference to FIG. 4.

The operatively coupled computing system may be configured in any of the above embodiments to automatically register image capture perspectives relative to each other based upon features of the captured images.

A large database of foot point clouds and surface models may be accumulated to be analyzed and potentially categorized by age, gender, weight, or other factors. Analysis may be conducted over periods of time to observe deltas—such as changes in the geometry or behavior of shoes, liners, orthotics, and/or feet over time.

RFID and other technologies may be utilized to interconnect shoes or components or accessories thereof with other subsystems, such as connected computers, mobile phones, laptops, wristbands, and the like, to report upon cyclic use and performance of the various items, and potentially related issues, such as possible orthopaedic problems that may be related to overuse of shoes—which may be related to creep deformation of shoe materials and/or change in Young's modulus of shoe, liner, or orthotic constructs. In one embodiment, the aforementioned analysis techniques may be utilized to assist in determining when shoes, liners, or orthotics have “worn out” based upon geometric changes in these structures which may be detected based upon foot imaging as well as foot-shoe assembly imaging.

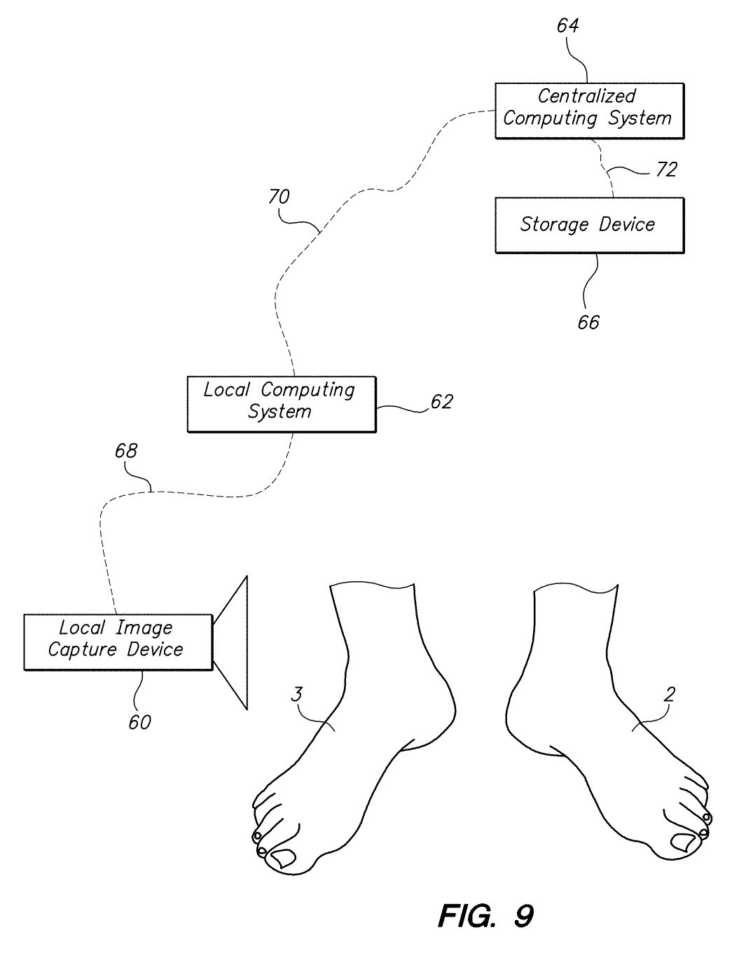

Referring to FIG. 9, one embodiment of a suitable system configuration is depicted wherein a local image capture device (such as a mono camera, such as an SLR camera or smartphone camera, a stereo camera, and/or a 3-D camera) is operatively coupled to a local computing system (such as a personal computer) via a wired or wireless connection, or via a memory device such as a flash memory device passed back and forth to transmit information (68). The local computing system (62) may be operatively coupled (70; such as by a wired or wireless internet connection) to a centralized computing system (64) which may be operatively coupled (72; such as by a wired or wireless internet connection) to a data storage device or system (66), such as a cloud data storage resource. The local image capture device may be configured to capture image information pertinent to a subject's foot from two or more different perspectives while the subject is standing upon a floor surface with and without a shoe, and to transmit such image information to the local computing system. The local computing system may be configured to transmit the image information to the centralized computing system to facilitate the centralized computing system in creating a surface model of the subject's foot, and to automatically analyze the fit of the shoe to the foot based at least in part upon a predetermined model of the geometry of the shoe that is stored on the centralized data storage device. The centralized computing system further may be configured to send back to the local computing system information regarding the surface model of the subject's foot and the fit of the shoe to the foot for display and analysis on the local computing system.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

Any of the devices described for carrying out the subject diagnostic or interventional procedures may be provided in packaged combination for use in executing such interventions. These supply “kits” may further include instructions for use and be packaged in trays or containers as commonly employed for such purposes.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A footwear configuration system, comprising:
a. a local image capture device operatively coupled to a local computing system; and
b. a centralized image processing and analysis computing system operatively coupled to the local computing system, the local image capture device, and a centralized data storage device;
wherein the local image capture device is configured to capture image information pertinent to a subject's foot from two or more different perspectives while the subject is standing upon a floor surface with and without a shoe, and to transmit such image information to the local computing system; and
wherein the local computing system is configured to transmit the image information to the centralized computing system to facilitate the centralized computing system in creating a surface model of the subject's foot, and to automatically analyze the fit of the shoe to the foot based at least in part upon a predetermined model of the geometry of the shoe that is stored on the centralized data storage device.

2. The system of claim 1, wherein the centralized computing system is further configured to send back to the local computing system information regarding the surface model of the subject's foot and the fit of the shoe to the foot for display and analysis on the local computing system.

3. The system of claim 1, wherein the local image capture device is selected from the group consisting of: a mono imaging device, a stereo imaging device, and a 3-D imaging device.

4. The system of claim 3, wherein the local image capture device is a mono imaging device selected from the group consisting of: an SLR camera and a cellphone camera.

5. The system of claim 3, wherein the local image capture device is a 3-D imaging device, and wherein the image information comprises a point cloud.

6. The system of claim 1, wherein the local image capture device is configured to capture the image information while the subject is standing on a textured surface.

7. The system of claim 1, wherein the local image capture device is configured to capture the image information while the subject is standing on the floor surface wearing a textured sock over the foot.

8. The system of claim 1, wherein the local image capture device is operatively coupled to the local computing system by a wireless data connection.

9. The system of claim 1, wherein the local image capture device is operatively coupled to the local computing system by a wired data connection.

10. The system of claim 1, wherein the local image capture device is operatively coupled to the local computing system by an exchanged memory device.

11. The system of claim 1, wherein the local computing system is operatively coupled to the centralized computing system by an internet connection modality.

12. The system of claim 11, wherein the internet connection modality is selected from the group consisting of: a wired network connection and a wireless network connection.

13. The system of claim 1, wherein the local computing device comprises a personal computer.

14. A method for footwear configuration, comprising:
a. capturing, using a local image capture device, image information pertinent to a subject's foot from two or more perspectives while the subject is standing upon a floor surface with and without a shoe;
b. transmitting the image information to a local computing system; and
c. utilizing the local computing system to transmit the image information to a centralized computing system to facilitate the centralized computing system in creating a surface model of the subject's foot, and to automatically analyze the fit of the shoe to the foot based at least in part upon a predetermined model of the geometry of the shoe that is stored on the centralized data storage device.

15. The method of claim 14, further comprising sending back to the local computing system information regarding the surface model of the subject's foot and the fit of the shoe to the foot for display and analysis on the local computing system.

16. The method of claim 15, further comprising utilizing the information regarding the surface model of the subject's foot and the fit of the shoe to the foot to select an appropriate shoe for the foot.

17. The method of claim 15, further comprising utilizing the information regarding the surface model of the subject's foot and the fit of the shoe to the foot to manufacture a customized shoe for the foot.
